(19) United States
(12) Patent Application Publication
(10) Pub. No.: US 2025/0244518 A1
(43) Pub. Date: Jul. 31, 2025

(54) BACKLIGHT MODULE FOR KEYBOARD

(71) Applicant: Chicony Power Technology Co., Ltd., New Taipei City (TW)

(72) Inventor: Wen-Yu Wu, New Taipei City (TW)

(73) Assignee: Chicony Power Technology Co., Ltd., New Taipei City (TW)

(21) Appl. No.: 18/658,195

(22) Filed: May 8, 2024

(30) Foreign Application Priority Data
Jan. 26, 2024 (TW) 113103219

(51) Int. Cl. F21V 8/00; H01H 13/83

(52) U.S. Cl. CPC G02B 6/0031; G02B 6/0036; H01H 13/83

(57) ABSTRACT

A backlight module for keyboard includes a circuit board with a first light-emitting element, a reflective layer between the circuit board and a light guide layer, and the light guide layer is arranged above the reflective layer. The reflective layer includes a first hollow part arranged corresponding to the first light-emitting element. The light guide layer includes a plurality of microstructures located on a side of the light guide layer, a first section, a second section and a third section. The circuit board is arranged corresponding to the first section. The first section includes a second hollow part arranged corresponding to the first hollow part and configured to accommodate the first light-emitting element. Two sides of the third section are correspondingly adjacent to the first section and the second section. The horizontal height of the first section is greater than the horizontal height of the second section.

### CROSS-REFERENCE TO RELATED APPLICATION

This non-provisional application claims priority under 35 U.S.C. § 119 (a) to patent application No. 113103219 filed in Taiwan, R.O.C. on Jan. 26, 2024, the entire contents of which are hereby incorporated by reference.

### BACKGROUND

### Technical Field

The present disclosure provides a backlight module, and particularly relates to a backlight module for a keyboard.

### Related Art

A backlight module for a keyboard includes a light-shielding sheet, a light guide sheet, a reflective sheet and a light bar which are arranged from top to bottom. In order to enable the light emitted by an LED of the light bar to enter the light guide sheet to the maximum extent and be completely transmitted to a light exit section of the light guide sheet, a coupling part between the LED of the light bar and the light guide sheet is one of the key factors in improving the overall lighting effect.

### SUMMARY

In view of this, some embodiments of the present disclosure provide a backlight module for a keyboard, which is suitable for increasing the amount of light entering a light guide layer from a first light-emitting element. In addition, the inventor recognized that light dissipation is prone to occur around a light entry surface of a current light guide layer, causing light loss in the amount of light transmitted through the light guide layer to a light exit section, resulting in a decrease in the brightness of the light exit section.

According to some embodiments of the present disclosure, provided is a backlight module for a keyboard, including a circuit board, a reflective layer and a light guide layer. The first light-emitting element is arranged on the circuit board. The reflective layer is arranged above the circuit board and includes a first hollow part, and the first hollow part is arranged corresponding to the first light-emitting element. The light guide layer is arranged above the reflective layer, and the light guide layer includes a plurality of microstructures, a first section, a second section and a third section. The plurality of microstructures are located on a side of the light guide layer. The first section includes a second hollow part, and the second hollow part is arranged corresponding to the first hollow part and configured to accommodate the first light-emitting element. One side of the third section is adjacent to the first section and the other side thereof is adjacent to the second section. A horizontal height of the first section is greater than that of the second section; and the circuit board is arranged corresponding to the first section.

According to some embodiments of the present disclosure, the backlight module for a keyboard further includes an optical structure; and the optical structure surrounds the second hollow part and is arranged on an upper surface or a lower surface of the first section.

According to some embodiments of the present disclosure, the backlight module for a keyboard further includes a film; the film is arranged above the light guide layer, and the film includes a light-shielding section and a first single-key light exit section; and a part of the light-shielding section is arranged corresponding to the second hollow part.

According to some embodiments of the present disclosure, the optical structure is optical cement that is used for bonding the light guide layer with the reflective layer or the film.

According to some embodiments of the present disclosure, the first single-key light exit section is arranged corresponding to the microstructures, so that light exits through the first single-key light exit section.

According to some embodiments of the present disclosure, the film further includes a second single-key light exit section; the first single-key light exit section is arranged in the first section, and the second single-key light exit section is arranged in the second section; and the number or light exit area of the microstructures corresponding to the first single-key light exit section is less than that of the microstructures corresponding to the second single-key light exit section.

According to some embodiments of the present disclosure, the film further includes the second single-key light exit section; the area of the first single-key light exit section is less than that of the second single-key light exit section, and the number or light exit area of the microstructures corresponding to the first single-key light exit section is less than that of the microstructures corresponding to the second single-key light exit section.

According to some embodiments of the present disclosure, the light guide layer further includes a first through hole located in the second section; the reflective layer is provided with a second through hole; the film is provided with a third through hole; and the first through hole, the second through hole and the third through hole correspond to one another.

According to some embodiments of the present disclosure, an angle is formed between a first light-emitting surface of the first light-emitting element and an axis of the adjacent first single-key light exit section, and the angle is less than 90°.

According to some embodiments of the present disclosure, a first included angle is formed between the first section and an inner surface of the third section; a second included angle is formed between the second section and an outer surface of the third section; and the first included angle and the second included angle are greater than 90°.

According to some embodiments of the present disclosure, the backlight module for a keyboard further includes a second light-emitting element; and the first light-emitting element and the second light-emitting element are different in light exit direction.

According to some embodiments of the present disclosure, the first section is a first slope; the third section is a second slope; the first slope and the second slope are slopes extending into a whole; and the second hollow part is located on a top end of the first slope of the first section.

According to some embodiments, a horizontal height of the first section of the light guide layer is greater than a horizontal height of the second section so that the light entry surface of the first section guides more light to enter the light guide layer, which increases the amount of light entering the light guide layer from the first light-emitting element. In addition, according to some embodiments, the optical structure is arranged on the upper surface or the lower surface of the first section and surrounds the second hollow part, so that the light of the first light-emitting element is reflected or refracted in the second hollow part, and thus the light scattering phenomenon is avoided in the second hollow part.

The objective, technical content, characteristics and achieved effects of the present disclosure will be more easily understood through detailed descriptions of specific embodiments in conjunction with the accompanying drawings below.

### BRIEF DESCRIPTION OF THE DRAWINGS

FIG. 1 is an exploded view of a backlight module according to some embodiments.

FIG. 2 is a top view of a backlight module according to some embodiments.

FIG. 2A is an enlarged view of a dashed box of a mark A in FIG. 2

FIG. 3 is a sectional view of a lead position of a mark B-B in FIG. 2.

FIG. 4 is a schematic diagram of a backlight module in light projection according to some embodiments.

FIG. 5 is a local side sectional view of an optical structure coating a light guide layer according to some embodiments.

FIG. 6 is a local side sectional view of a backlight module with a slope on bottom of a light guide layer according to some embodiments.

FIG. 7 is a local side sectional view of a backlight module with slopes on surface and bottom of a light guide layer according to some embodiments.

FIG. 8 is a local side sectional view of a backlight module with same slopes in a first section and a third section of a light guide layer according to some embodiments.

FIG. 9 is a top view of a backlight module according to some embodiments.

### DETAILED DESCRIPTION

Each embodiment of the present disclosure will be described in detail below, with drawings as examples. In the description of the specification, many specific details are provided in order to enable the reader to have a more complete understanding of the present disclosure. However, the present disclosure may still be practiced without some or all of the specific details. The same or similar elements in the drawings will be represented by the same or similar symbols. It is to be noted that the drawings are for schematic purposes only and do not represent the actual size or quantity of components. Some details may not be fully drawn for the sake of simplicity.

In order to describe this application more clearly, in the drawings provided in this application, a first axis X is an X axis of a three-dimensional coordinate system, a second axis Y is a Y axis of the three-dimensional coordinate system, and a third axis Z is an Z axis of the three-dimensional coordinate system.

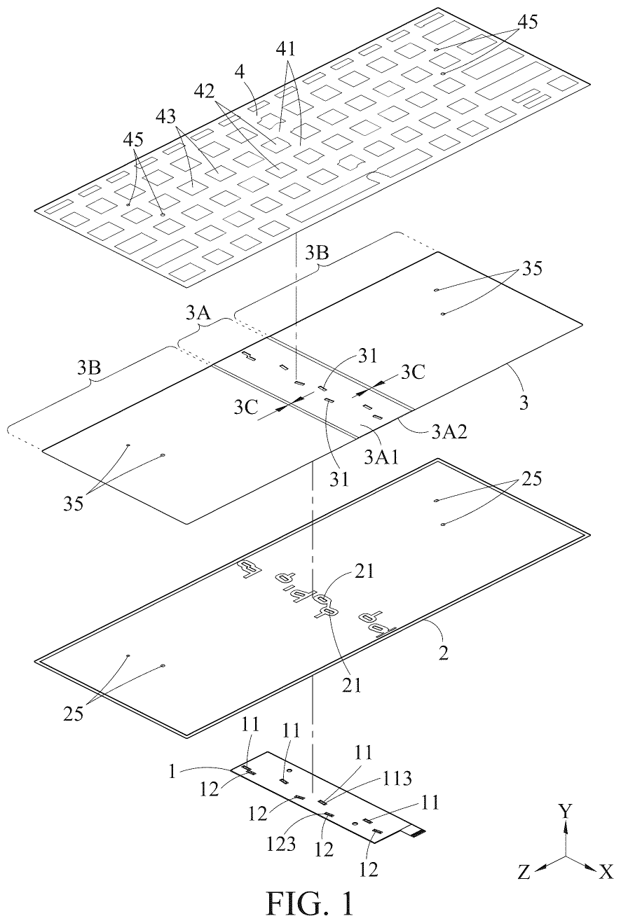

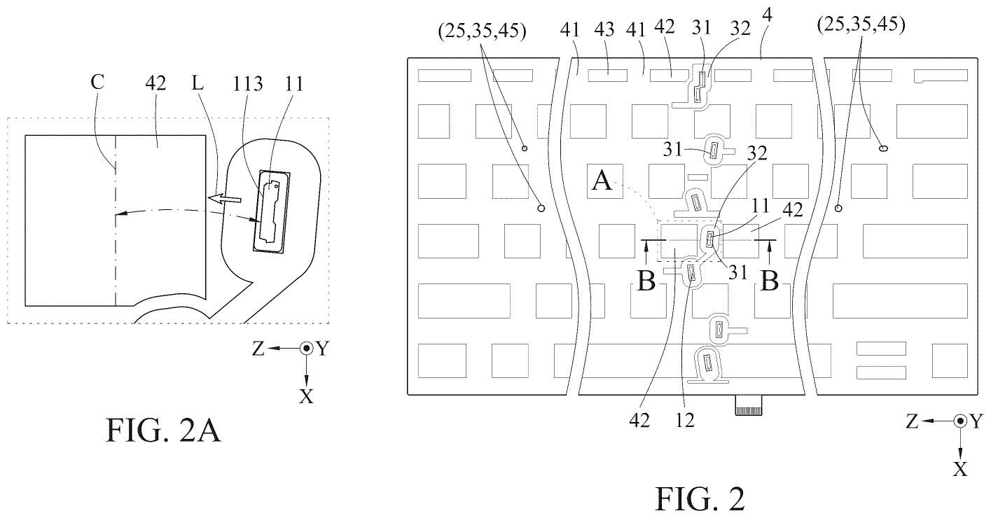

As shown in FIG. 1 and FIG. 2, FIG. 1 is an exploded view of a backlight module. FIG. 2 is a top view of a backlight module. A backlight module for a keyboard includes a circuit board 1, a reflective layer 2 and a light guide layer 3. A first light-emitting element 11 (one or more) is arranged on the circuit board 1. The first light-emitting element 11 is arranged on a surface of the circuit board 1. A first light-emitting surface 113 is arranged on a side of the first light-emitting element 11. The first light-emitting surface 113 of the first light-emitting element 11 faces one of the two sides of the circuit board 1. Because the first light-emitting element 11 is located in about the center of the light guide layer 3, the first light-emitting element 11 emits light from one side and approximately emits light towards one of the two sides of the light guide layer 3 along the third axis Z.

As shown in FIG. 1 and FIG. 2, the reflective layer 2 is arranged above the circuit board 1. The reflective layer 2 includes a first hollow part 21. The first hollow part 21 is arranged corresponding to the first light-emitting element 11. The light guide layer 3 is arranged above the reflective layer 2. The reflective layer 2 and the light guide layer 3 are each of a long rectangular thin structure.

As shown in FIG. 2 and FIG. 2A, FIG. 2A is an enlarged view of a dashed box marked with A in FIG. 2. In some embodiments, by overlooking first single-key light exit section 42 of a film 4 and a section corresponding to the first light-emitting element 11 from top to bottom along the second axis Y, an angle is formed between the first light-emitting surface 113 of the first light-emitting element 11 and an axis C of the adjacent first single-key light exit section 42, and the angle is greater than 5° and less than 90°. Light L emitted by the first light-emitting element 11 may avoid a first through hole 35, thus avoiding the problem of uneven lighting effect or local shadow. Moreover, the light L can irradiate each first single-key light exit section 42 needing light exit and corners of the keyboard.

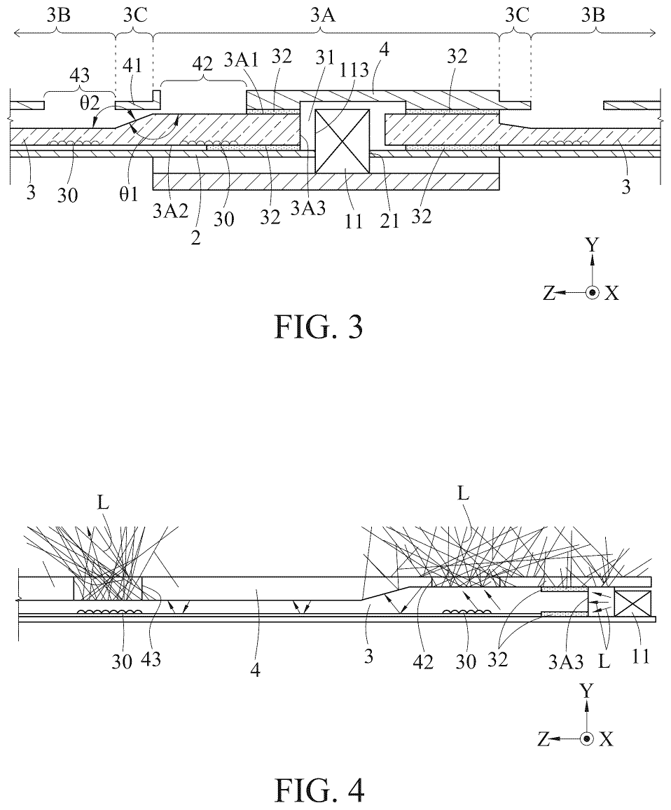

As shown in FIG. 1 to FIG. 3, FIG. 3 is a sectional view of a position marked with B-B in FIG. 2. The light guide layer 3 includes a plurality of microstructures 30, a first section 3A, a second section 3B and a third section 3C. The plurality of microstructures 30 are respectively located on a side of the light guide layer 3. One side of the third section 3C of the light guide layer 3 is adjacent to the first section 3A. The other side of the third section 3C is adjacent to the second section 3B. In some embodiments, as shown in FIG. 1, by viewing the light guide layer 3 from top to bottom along the second axis Y, the light guide layer 3 is divided into three sections; the first section 3A is located in the middle of the light guide layer 3; the second section 3B are located on two outer sides of the light guide layer 3; and the third section 3C are located between two sides of the first section 3A and two second sections 3B. In some embodiments, the first section 3A and the second section 3B of the light guide layer 3 are planar. The third section 3C of the light guide layer 3 is a slope connected to the first section 3A and the second section 3B, respectively.

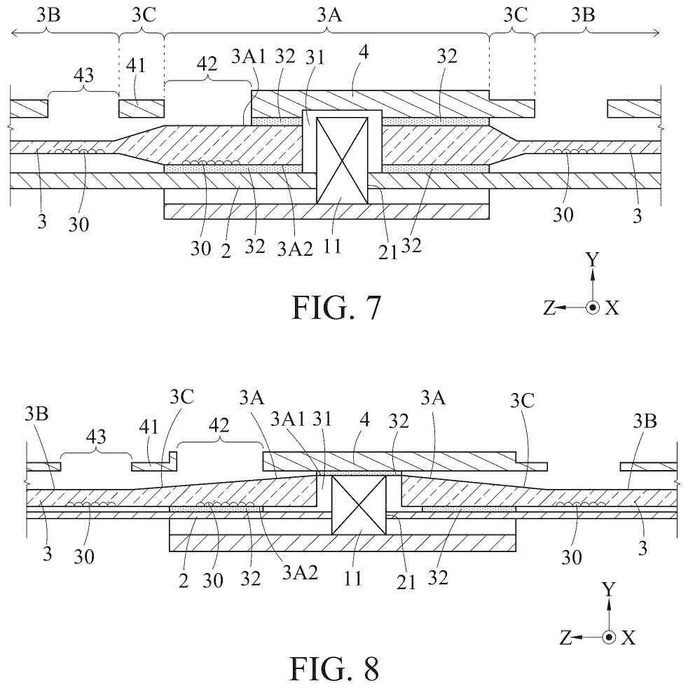

In some embodiments, a surface of the third section 3C of the light guide layer 3 is set to be sloped, and a bottom of the light guide layer 3 is set to be planar, but it is not limited thereto. In some embodiments, a bottom of the third section 3C of the light guide layer 3 is set to be sloped. A surface of the light guide layer 3 is set to be planar (as shown in FIG. 6), but it is not limited thereto. In some embodiments, the surface and the bottom of the third section 3C of the light guide layer 3 are set to be sloped (as shown in FIG. 7), but it is not limited thereto. In some embodiments, the first section 3A of the light guide layer 3 is a first slope. The third section 3C is a second slope. The first slope and the second slope are slopes extending at a same angle of slope. A second hollow part 31 is located between top ends of the first slopes formed by the first sections 3A (as shown in FIG. 8). The lighting effects achieved by the slopes at different positions on the light guide layer 3 will be described later.

The circuit board 1 is arranged corresponding to the first section 3A of the light guide layer 3. The first section 3A of the light guide layer 3 includes the second hollow part 31. The second hollow part 31 is arranged corresponding to the first hollow part 21 and configured to accommodate the first light-emitting element 11. In some embodiments, the first section 3A of the light guide layer 3 is provided with a light entry surface 3A3 on an inner side of the second hollow part 31. The first light-emitting surface 113 of the first light-emitting element 11 faces the light entry surface 3A3.

As shown in FIG. 3, in terms of the second axis Y, a horizontal height of the first section 3A of the light guide layer 3 is greater than that of the second section 3B of the light guide layer 3, so the light guide layer 3 has different thicknesses in the first section 3A and the second section 3B.

A first included angle θ1 is formed between the first section 3A of the light guide layer 3 and an inner surface of the third section 3C. A second included angle θ2 is formed between the second section 3B and an outer surface of the third section 3C. The first included angles θ1 and the second included angle θ2 are respectively greater than 90° but less than 180°. The first included angle θ1 and the second included angle θ2 are respectively obtuse angles but not right angles, so the light Lis prevented from being emitted from a vertical plane of the right angle.

The third section 3C of the light guide layer 3 is a slope; and a sloped length of the slope, the first included angle θ1 and the second included angle θ2 are set according to factors such as the horizontal height of the first section 3A and the second section 3B of the light guide layer 3 and a distance therebetween. For example, in terms of the second axis Y, the higher the horizontal height of the first section 3A is above the horizontal height of the second section 3B, steeper the slope of the third section 3C is, and the closer the first included angle θ1 and the second included angle θ2 are to 90°. The closer the first section 3A is to the second section 3B, the steeper the slope of the third section 3C is, and the closer the first included angle θ1 and the second included angle θ2 are to 90°.

In some embodiments, the closer the first included angle θ1 or the second included angle θ2 of the light guide layer 3 is to 180°, the closer the slope of the light guide layer 3 in the third section 3C is to be parallel to the third axis Z, i.e., the closer the horizontal height of the first section 3A and the horizontal height of the second section 3B are to a plane state. Therefore, when the light L that has entered the light guide layer 3 is reflected by the gentle surface of the third section 3C, the light L can be effectively transmitted to the second section 3B and achieves total reflection.

In some embodiments, the first included angle θ1 is greater than 90°, and the second included angle θ2 is greater than 90°. When the light L of the first light-emitting element 11 is transmitted into the light guide layer 3, the light L may be subjected to, for example, but not limited to, second reflection or third reflection through the slope of the third section 3C, so as to achieve total reflection.

As shown in FIG. 3, when the light L of the first light-emitting element 11 is emitted to the light entry surface 3A3 of the first section 3A from the first light-emitting surface 113, a height of the first section 3A of the light guide layer 3 along the second axis Y is closer to a height of the first light-emitting element 11 than a height of the second section 3B, thus more light L can be guided to enter the light guide layer 3, which effectively increases the amount of light L entering the light guide layer 3 from the first light-emitting element 11.

After the light L of the first light-emitting element 11 enters the light guide layer 3 from the light entry surface 3A3, part of the light L will be projected to the slope of the third section 3C. Because the third section 3C is arranged to be a slope with an obtuse angle, the light L is reflected through the slope of the third section 3C, thus more light L is effectively transmitted to the second section 3B with relatively small sectional area, which increases the brightness of the exiting light.

As shown in FIG. 3, in terms of the second axis Y, the first section 3A of the light guide layer 3 and a top of the first light-emitting element 11 are at different horizontal heights. Due to the height difference between the light guide layer 3 and the first light-emitting element 11, the space above the light guide layer 3 or the first light-emitting element 11 can be effectively utilized, which relatively increases the utilization space in the keyboard.

As shown in FIG. 1 and FIG. 3, in some embodiments, the backlight module for a keyboard further includes the film 4 arranged above the light guide layer 3. The film 4 includes a light-shading section 41 (a black out part) and the first single-key light exit section 42 (a transparent part). The first single-key light exit section 42 corresponds to a key section of the keyboard. Part of the light-shading section 41 is arranged corresponding to the second hollow part 31. The first single-key light exit section 42 of the film 4 is arranged corresponding to the microstructures 30 of the light guide layer 3. The orthographic projection of the first single-key light exit section 42 relative to the light guide layer 3 is approximately overlapped with the microstructures 30, so the light L exits through the first single-key light exit section 42. Therefore, the light L is subjected to total reflection propagation in the light guide layer 3. Part of the light Lis scattered by the microstructures 30 and goes upwards from the first single-key light exit section 42. The rest of the light Lis blocked by the light-shading section 41 or reflected back to the light guide layer 3 so as to avoid light leakage.

As shown in FIG. 2 and FIG. 3, in some embodiments, the backlight module further includes optical structures 32. The optical structures 32 surround the second hollow part 31 (an accommodating hole) and are arranged on an upper surface 3A1 and/or a lower surface 3A2 of the first section 3A, so this section has a light reflection or light refraction effect, avoiding the light dissipation phenomenon. Moreover, the optical structures 32 surrounding the second hollow part 31 are positioned corresponding to part of the light-shading section 41 of the film 4.

In some embodiments, in order to adjust the lighting effect, the optical structures 32 are arranged on the upper surface 3A1 and/or the lower surface 3A2 of the first section 3A and surround the second hollow part 31. When the light L that has entered the light guide layer 3 is projected to the optical structures 32 on the upper surface 3A1 and the lower surface 3A2 of the first section 3A, the light dissipation phenomenon can be avoided because the section of the optical structures 32 have the light reflection or light refraction effect. The slope of the third section 3C is arranged on the surface of the light guide layer 3, so when the light L is continuously transmitted in the light guide layer 3, the light L will be projected to the slope of the third section 3C on the surface of the light guide layer 3. The third section 3C is arranged to be the slope with an obtuse angle, so the light L will be reflected through the slope of the third section 3C so as to be effectively transmitted to the second section 3B, thus achieving total reflection.

In some embodiments, the optical structures 32 are optical cement or lattice points. Coating sections of the optical structures 32 form a planar closed ring around the second hollow part 31. A width of the optical structure 32 is greater than 1.5 mm. When the optical structures 32 without light adjusting effect are arranged on upper and lower sides near the second hollow part 31 of the light guide layer 3, or the optical structures 32 with light adjusting effect are not arranged at the above positions, the light L will exit from the light entry surface of the light guide layer 3 and be lost, thus the light L entering the second section 3B and the third section 3C in the light guide layer 3 is reduced, and as a result, the brightness of the overall single-key light exit section will be reduced. In some embodiments, the optical structures 32 are used for bonding the light guide layer 3 with the reflective layer 2 or the film 4. The optical structures 32 on the upper surface 3A1 and the lower surface 3A2 of the first section 3A of the light guide layer 3 are combined with the reflective layer 2 and the film 4 respectively, and thus the bonding between the structures is more solid.

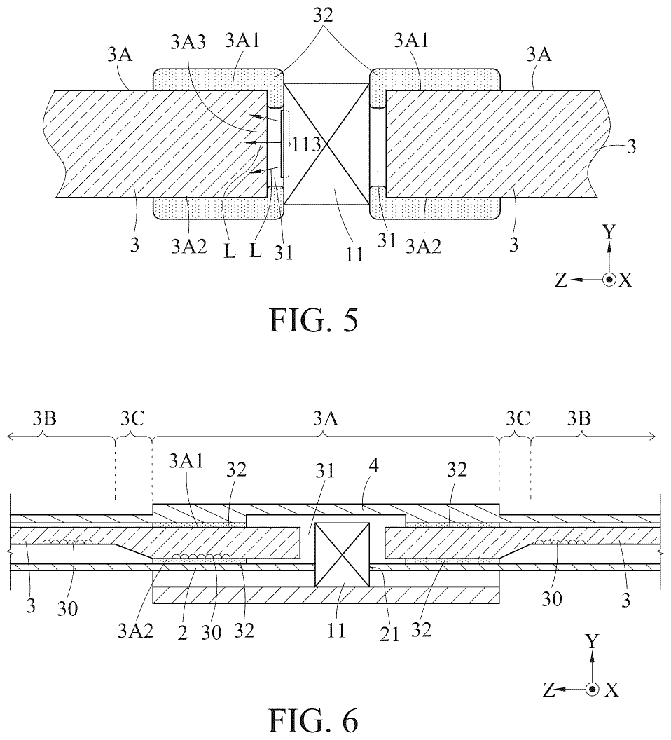

In some embodiments, the backlight module further includes a plurality of optical structures 32. The optical structures 32 are arranged on the upper surface 3A1 and the lower surface 3A2 of the first section 3A respectively and surround the second hollow part 31 (as shown in FIG. 3 and FIG. 5). When the light L of the first light-emitting element 11 is emitted to the light entry surface 3A3 of the light guide layer 3, the optical structures 32 on the light guide layer 3 are used for blocking or reflecting part of the light L of the first light-emitting element 11, which prevents the light L that has entered the light guide layer 3 is prevented from dissipating and exiting around the light entry surface 3A3, thereby reducing light losses caused by light dissipation at the light entry position of the light guide layer 3, and effectively guiding the light L back into the light guide layer 3 and transmitting to a deeper light exit section in the light guide layer 3. Moreover, there will not be a large amount of light L concentrated around the light entry surface 3A3 of the first section 3A.

As shown in FIG. 3 and FIG. 5, FIG. 5 is a local side sectional view of an optical structure coating a light guide layer. In some embodiments, after the optical structure 32 (optical cement) is processed and coated on the surface, close to the peripheral section of the second hollow part 31, of the light guide layer 3, part of the optical cement will flow into the second hollow part 31 (accommodating hole) due to the flow characteristic, thus part of the optical structure 32 is located between the light entry surface 3A3 of the light guide layer 3 and the first light-emitting element 11. Moreover, with the control over concentration and cement amount of the optical structure 32 (optical cement), the optical cement will not block the first light-emitting surface 113 of the first light-emitting element 11 due to excessive flow to influence the light emitting amount.

As shown in FIG. 2 and FIG. 4, FIG. 4 is a schematic diagram of a backlight module in light projection. In some embodiments, the film 4 further includes a second single-key light exit section 43. When the film 4 is combined with the light guide layer 3, the first single-key light exit section 42 of the film 4 is correspondingly arranged at the position of the first section 3A, and the second single-key light exit section 43 of the film 4 is correspondingly arranged at the position of the second section 3B. The plurality of microstructures 30 on the light guide layer 3 correspond to the first single-key light exit section 42 and the second single-key light exit section 43 respectively. The number or the light exit area of the microstructures 30 corresponding to the first single-key light exit section 42 is less than that of the microstructures 30 corresponding to the second single-key light exit section 43. Therefore, when the light L that has entered the light guide layer 3 is projected to the microstructures 30 of the first single-key light exit section 42 and the second single-key light exit section 43 respectively, because light L receiving density of the first single-key light exit section 42 which is relatively close to the first light-emitting element 11 is greater than that of the second single-key light exit section 43, the amount of exiting light scattered by the microstructures 30 of the first single-key light exit section 42 is less than that of exiting light L scattered by the microstructures 30 of the second single-key light exit section 43, thus the overall brightness of all the single-key light exit section is consistent, and the problem of uneven overall appearance brightness caused by distance is solved.

In some embodiments, the first single-key light exit section 42 of the film 4 is arranged closer to the first light-emitting element 11 than the second single-key light exit section 43. On the light guide layer 3, the number or light exit area of the plurality of microstructures 30 corresponding to the first single-key light exit section 42 is less than the number or light exit section of the plurality of microstructures 30 corresponding to the second single-key light exit section 43. Therefore, the overall brightness of all the single-key light exit sections is consistent. The problem of uneven overall appearance brightness caused by distance is avoided.

As shown in FIG. 6 and FIG. 7, FIG. 6 is a local side sectional view of a backlight module with a slope on bottom of a light guide layer, and FIG. 7 is a local side sectional view of a backlight module with slopes on surface and bottom of a light guide layer. In order to adjust the lighting effect, the optical structures 32 are arranged on the upper surface 3A1 and the lower surface 3A2 of the first section 3A and surround the second hollow part 31. When the light L that has entered the light guide layer 3 is projected to the optical structures 32 on the upper surface 3A1 and the lower surface 3A2 of the first section 3A, the sections of the optical structures 32 achieve the light reflection or light refraction effect, and thus the light dissipation phenomenon is avoided. In some embodiments, as shown in FIG. 6, the slope of the third section 3C is arranged on the bottom of the light guide layer 3, so when the light L is continuously transmitted in the light guide layer 3, the light L will be projected to the slope of the third section 3C located on the bottom of the light guide layer 3. The third section 3C is arranged to be the slope with an obtuse angle, so the light L will be reflected through the slope of the third section 3C so as to be effectively transmitted to the second section 3B, thus achieving total reflection. In some embodiments, as shown in FIG. 7, two slopes of the third section 3C are arranged on the surface and bottom of the light guide layer 3 respectively, so when the light Lis continuously transmitted in the light guide layer 3, the light L will be projected to the two slopes of the third section 3C located on the surface and bottom of the light guide layer 3. The third section 3C that is relatively convergent and tapered is arranged to be the slope with an obtuse angle, so the light L is reflected through the two slopes of the third section 3C so as to be effectively transmitted to the second section 3B to achieve total reflection.

As shown in FIG. 8, FIG. 8 is a local side sectional view of a backlight module with a same slope in a first section and a third section of a light guide layer. In some embodiments, in order to adjust the lighting effect, the optical structures 32 are arranged on the upper surface 3A1 and the lower surface 3A2 of a top end of the first section 3A and surround the second hollow part 31. When the light L that has entered the light guide layer 3 is projected to the optical structures 32 on the upper surface 3A1 and the lower surface 3A2 of the top end of the first section 3A, the sections of the optical structures 32 achieve the light reflection or light refraction effect, and the light dissipation phenomenon is avoided. The first section 3A and the third section 3C which are arranged on the surface of the light guide layer 3 are a same slope, so when the light Lis transmitted into the light guide layer 3, the light L will be projected to the same slope of the first section 3A and the third section 3C which are located on the surface of the light guide layer 3. The first section 3A and the third section 3C are arranged to be the slope with an obtuse angle, so the light L is reflected through the slope of the first section 3A and the third section 3C so as to be effectively transmitted to the second section 3B to achieve total reflection.

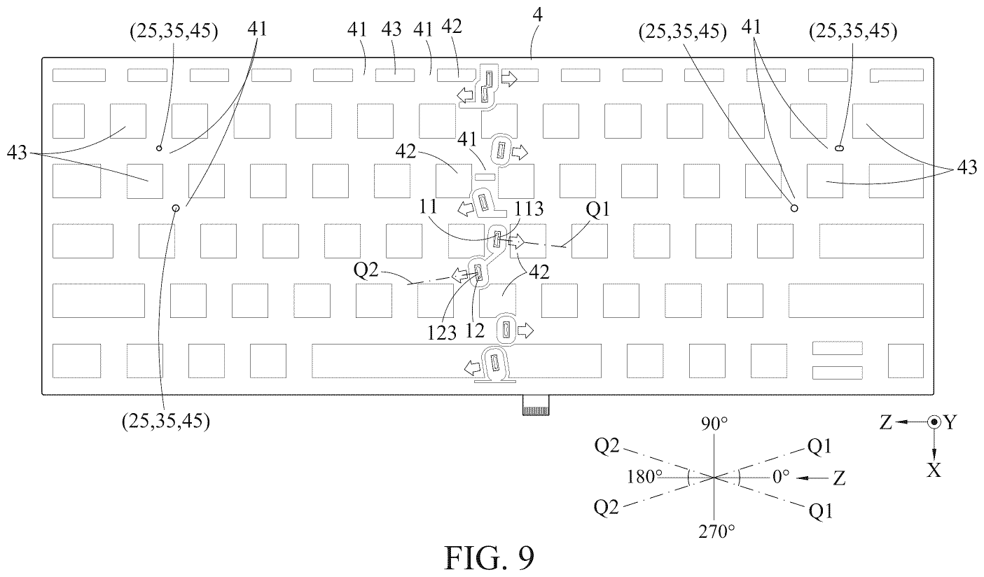

As shown in FIG. 1 and FIG. 9, FIG. 9 is a top view of a backlight module. In some embodiments, the light guide layer 3 further includes a first through hole 35 located in the second section 3B. The reflective layer 2 is provided with a second through hole 25. The film 4 is provided with a third through hole 45. The first through hole 35, the second through hole 25 and the third through hole 45 correspond to one another. The first through hole 35, the second through hole 25 and the third through hole 45 play a role in heat dissipation. The first through hole 35, the second through hole 25 and the third through hole 45 are used for arranging positioning parts so as to position the light guide layer 3, the reflective layer 2 and the film 4.

In some embodiments, in order to enable the light L of the first light-emitting element 11 to be evenly irradiated to corners of the keyboard, a light exit direction or angle of the first light-emitting surface 113 of the first light-emitting element 11 is adjusted. For example, an angle between a first light-emitting axis Q1 in the center of the first light-emitting element 11 and the third axis Z is adjusted, or an angle between the first light-emitting surface 113 and the axis C (shown in FIG. 2A) of the adjacent first single-key light exit section 42 is adjusted, thus the light L emitted by the first light-emitting element 11 will avoid the first through hole 35, and the problem of uneven lighting effect or local shadow is avoided. Moreover, the light L can be irradiated to the first single-key light 42 needing light emitting and the corners of the keyboard.

In some embodiments, the backlight module for a keyboard further includes a second light-emitting element 12. The first light-emitting element 11 and the second light-emitting element 12 are different in light exit direction. The light L emitted by the first light-emitting element 11 and the second light-emitting element 12 in different light exit directions can share the illumination requirements of all the corners of the keyboard so as to achieve the light equalizing effect. As shown in FIG. 1, in some embodiments, a plurality of first light-emitting elements 11 and a plurality of second light-emitting elements 12 are arranged on the circuit board 1. The reflective layer 2 includes a plurality of first hollow parts 21. All the first hollow parts 21 correspond to the first light-emitting elements 11 and the second light-emitting elements 12, respectively. By overlooking along the second axis Y, all the first light-emitting elements 11 and all the second light-emitting elements 12 are adjacent to one another and arranged in a staggered mode, thus all the first light-emitting elements 11 and all the second light-emitting elements 12 will emit the light L towards the two sides of the light guide layer 3 respectively, so as to uniformly irradiate the light to various corners of the keyboard.

In some embodiments, when the third axis Z is at 0°, an angle between the first light-emitting axis Q1 in the center of each first light-emitting element 11 and the third axis Z is less than +/−90°. In some embodiments, an angle is formed between the first light-emitting surface 113 and the axis C of the adjacent first single-key light exit section 42, and the angle is less than 90° but greater than 5°, thus the light L emitted by each first light-emitting element 11 can avoid two first through holes 35 on the right in FIG. 9, and the problem of uneven lighting effect or local shadow is avoided. Moreover, the light L can irradiate each first single-key light exit section 42 needing light exiting and the corners of the keyboard.

In some embodiments, when the third axis Z is at 0°, an angle between a second light-emitting axis Q2 in the center of each second light-emitting element 12 and the third axis Z is greater than +/−90° (91° to 269° as shown in FIG. 9). An angle is formed between a second light-emitting surface 123 and the axis C of the adjacent first single-key light exit section 42, and the angle is less than 90° but greater than 5°, thus the light L emitted by each second light-emitting element 12 can avoid two first through holes 35 on the left in FIG. 9, and the problem of uneven lighting effect or local shadow is avoided. Moreover, the light L can irradiate each first single-key light exit section 42 needing light emitting and the corners of the keyboard.

In conclusion, according to some embodiments, the horizontal height of the first section of the light guide layer is greater than that of the second section, so the light entry surface of the first section can guide more light to enter the light guide layer, which effectively increases the amount of light entering the light guide layer from the first light-emitting element. In addition, according to some embodiments, the optical structure is arranged on the upper surface or the lower surface of the first section and surrounds the second hollow part, so that the light of the first light-emitting element is reflected or refracted by the light guide layer at the section close to the second hollow part, and thus the light guide layer is prevented from the light dissipation phenomenon at the section close to the second hollow part.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

1. A backlight module for a keyboard, comprising:
a circuit board, provided with a first light-emitting element;
a reflective layer, arranged above the circuit board and comprising a first hollow part that is arranged corresponding to the first light-emitting element; and
a light guide layer, arranged above the reflective layer and comprising:
a plurality of microstructures, located on a side of the light guide layer;
a first section, comprising a second hollow part that is arranged corresponding to the first hollow part and configured to accommodate the first light-emitting element;
a second section; and
a third section, with one side being adjacent to the first section and the other side being adjacent to the second section,
wherein a horizontal height of the first section is greater than that of the second section; and the circuit board is arranged corresponding to the first section.

2. The backlight module for a keyboard according to claim 1, further comprising an optical structure, the optical structure surrounding the second hollow part and arranged on an upper surface or a lower surface of the first section.

3. The backlight module for a keyboard according to claim 2, further comprising a film, the film being arranged above the light guide layer and comprising a light-shielding section and a first single-key light exit section; and part of the light-shielding section is arranged corresponding to the second hollow part.

4. The backlight module for a keyboard according to claim 3, wherein the optical structure is optical cement that is used for bonding the light guide layer with the reflective layer or the film.

5. The backlight module for a keyboard according to claim 4, wherein the first single-key light exit section is arranged corresponding to the microstructures, and thus light exits through the first single-key light exit section.

6. The backlight module for a keyboard according to claim 5, wherein the film further comprises a second single-key light exit section; the first single-key light exit section is arranged in the first section, and the second single-key light exit section is arranged in the second section; the number or light exit area of the microstructures corresponding to the first single-key light exit section is less than that of the microstructures corresponding to the second single-key light exit section.

7. The backlight module for a keyboard according to claim 5, wherein the film further comprises a second single-key light exit section; the area of the first single-key light exit section is less than that of the second single-key light exit section; and the number or light exit area of the microstructures corresponding to the first single-key light exit section is less than that of the microstructures corresponding to the second single-key light exit section.

8. The backlight module for a keyboard according to claim 4, wherein the light guide layer further comprises a first through hole located in the second section; the reflective layer is provided with a second through hole; the film is provided with a third through hole; and the first through hole, the second through hole and the third through hole correspond to one another.

9. The backlight module for a keyboard according to claim 4, wherein an angle is formed between a first light-emitting surface of the first light-emitting element and an axis of the adjacent first single-key light exit section, and the angle is less than 90°.

10. The backlight module for a keyboard according to claim 1, wherein a first included angle is formed between the first section and an inner surface of the third section; a second included angle is formed between the second section and an outer surface of the third section; and the first included angle and the second included angle are greater than 90°.

11. The backlight module for a keyboard according to claim 1, further comprising a second light-emitting element, wherein the first light-emitting element and the second light-emitting element are different in light exit direction.

12. The backlight module for a keyboard according to claim 1, wherein the first section is a first slope; the third section is a second slope; the first slope and the second slope are slopes extending into a whole; and the second hollow part is located on a top end of the first slope of the first section.
